(19) United States
(12) Patent Application Publication
(10) Pub. No.: US 2018/0051226 A1
(43) Pub. Date: Feb. 22, 2018

(54) (PER)FLUOROPOLYETHER POLYMERS AS DAMPING FLUIDS

(71) Applicant: SOLVAY SPECIALTY POLYMERS ITALY S.P.A., Bollate (IT)

(72) Inventors: Ugo DE PATTO, Cogliate (IT); Sara ROVINETTI, Garbagnate Milanese (IT); Giovanni BOCCALETTI, Roncoferraro (IT); Fabio RIGANTI, Milano (IT)

(21) Appl. No.: 15/561,225

(22) PCT Filed: Mar. 22, 2016
(86) PCT No.: PCT/EP2016/056219

§ 371 Date: Sep. 25, 2017

(30) Foreign Application Priority Data
Mar. 25, 2015 (EP) 15160745.4

(51) Int. Cl. C10M 147/04

(52) U.S. Cl. CPC C10M 147/04; C10M 2205/0206; C10M 2213/043; C08L 27/18; C10N 2220/022; C10N 2230/08; C10N 2230/76; C10M 2213/0606

(57) ABSTRACT

The present invention relates to the use of highly viscous (per)fluoropolyether polymers as damping fluids and to a method for counteract vibrations and/or shocks in a device using highly viscous (per)fluoropolyether polymers.

### CROSS REFERENCE TO RELATED APPLICATIONS

This application claims priority from European application No. 15160745.4 filed on 25 Mar. 2015, the whole content of this application being incorporated herein by reference for all purposes.

### TECHNICAL FIELD

The present invention relates to the use of (per)fluoropolyether polymers having high viscosity as damping fluids.

### BACKGROUND ART

Generally, damping is an influence within or upon an oscillatory system that has the effect of reducing, restricting or preventing its oscillations. This is typically obtained by dissipating the energy stored in the oscillation. Dampers, such as shock absorbers or dashpots, are devices designed to absorb and damp shock impulses by converting the kinetic energy of the shock into another form of energy (typically heat), which is then dissipated.

Dampers comprising a viscous fluids (also referred to as “damping fluids”) are widely used in many fields. For example, dampers are mounted in skyscrapers and in other civil structures (e.g. bridges, towers, elevated freeways) for suppressing earthquake- and wind-induced vibrations, in power transmission lines, in spacecraft and in particular in automotive. In the latter, shock absorbers are assembled in suspension systems, to absorb shock encountered while traversing uneven terrain. Also, torsional dampers are used to reduce the torsional vibrations in the crankshafts of internal combustion engines, as these vibrations can break the crankshaft itself or cause driven belts, gears and attached components to fail.

Nowadays, highly viscous silicone oils (i.e. having a viscosity up to 2,000,000 mm²/s at 20° C.) are widely used as damping fluids, either alone or in admixture with other suitable ingredients, such as for example stabilizers, because of their good temperature-viscosity properties and high shear stability.

Compositions that can be used as damping fluids are also already known in the art. For example, U.S. Pat. No. 3,701,732 (MONSANTO CO.) discloses compositions as functional fluids, including among the others damping fluids, which comprise organo-silicates and a perfluorinated alkylene ether-containing compound in an amount of from 0.005-15 wt. %. Polymeric viscosity index improvers (such as alkyl esters of alpha-beta unsaturated monocarboxylic acids) can be added to the composition. No indication about the viscosity of the final composition is given.

U.S. Pat. No. 4,251,381 discloses a damping agent for damping mechanical and/or acoustical vibrations, which consists of a fluid phase consisting of silicone oils, polyols, mineral oils and/or saturated aliphatic or aromatic carboxylic acid esters containing groups graphite and at least one wet-agent. A silicone oil having a viscosity of about 20 cSt at 25° C. can be used as the fluid phase.

U.S. Pat. No. 4,657,687 (MONTEDISON S.P.A.) discloses lubricant compositions comprising (A) a PFPE having a viscosity from 150-2000 cSt (at 20° C.) and (B) a PFPE having a viscosity of less than 50 cSt (at 20° C.). The composition can be used in the impregnation of magnetic nuclei of electromagnetic recorder and in such case the composition reduces or damps the vibrations of the metal armature and of the contacts.

EP 0589637 (DOW CORNING CORP.) discloses an electro-rheological fluid comprising a dispersion of a plurality of solid particles in an electrically non-conducting liquid that is a mixture of (A) an organosiloxane and (B) an electrically non-conducting liquid selected from PFPE et al., with the proviso that the mixture has a viscosity of below 10,000 cSt at 25° C. The perfluorinated fluids is such that its viscosity is less than 500 cSt at 25° C.

WO 00/63579 (DEERE & CO.) discloses a damping fluid for a vibration damper, the damping medium being a fluid that changes its flowability (viscosity and/or physical state) in case of changes in temperature and pressure. The basic oil of the fat is a fluorinated polyether oil. No indication about the viscosity of the final composition is given. In addition, this document does not disclose (per)fluoropolyether copolymers, notably comprising recurring units derived from (per)fluoropolyether and recurring units derived from at least one olefin and their use as damping fluids

U.S. Pat. No. 5,864,968 (MORRIS A. MANN) discloses an article of footwear with an insole containing a material which resists breakdown after repeated use, which is more specifically a perfluoropolyether. The viscosity values of the perfluoropolyethers are generally in the range of from 30 to 5,000 cSt at 20° C. Both neutral and functionalized perfluoropolyethers are described as being useful. Preferred liquid perfluoropolyethers are those having the branched chemical structure reported herein after:

CF₃—[(OCF(CF₃)—CF₂)ₙ—(OCF₂)ₘ]—OCF₃

Polymer belonging to the series of Fomblin® HC, having a kinematic viscosity at 20° C. of 40, 250 and 1300 cSt are disclosed as preferred. The shock absorbing characteristics of perfluoropolyether are said to be improved when high- and low-viscosity perfluoropolyether are used in combination with a gas cushion to form a composite, cushioning insole. High viscosity perfluoropolyethers have a viscosity generally ranging from above 2,000 to 25,000 and typically from 6,000 to 12,000; and low viscosity perfluoropolyethers have a viscosity generally ranging from 200 to 2,000, and typically from 500 to 1,500. For these values, neither the temperature nor the measurement unit are explicitly mentioned. In addition, this document does not disclose (per)fluoropolyether copolymers, notably comprising recurring units derived from (per)fluoropolyether and recurring units derived from at least one olefin and their use as damping fluids.

JP H0673370 (NTN CORP.) discloses a damper sealant that is put in contact with a slidable member in order to prevent the leakage of an energy-absorbing fluid in a bumper or damper and is made of a lubricating rubber composition comprising (A) a thermoplastic fluororesin, (B) a fluororubber and (C) low molecular fluorine-containing polymer. In the description, as examples of component (C) the following are mentioned: tetrafluoroethylene polymer, fluoropolyether and polyfluoroalkyl. The fluoropolyethers have notably the following structures:

CF₃O(C₂F₄)ₘ(CF₂O)ₙ—CF₃

CF₃O(CF₂CF(CF₃)O)ₘ(CF₂O)ₙ—CF₃

CF₃O(CF(CF₃)CF₂O)ₘ(CF₂O)ₙ—CF₃

However, while this document discloses a damper sealant, it is silent about the use of fluoropolyethers as damping fluids to be used in order to counteract vibrations and/or shocks in a damper device.

### SUMMARY OF INVENTION

The Applicant perceived that the highly viscous silicone oils currently used as damping fluids suffer from some disadvantages, such as sensitivity to acids, bases and moisture and in particular thermal instability. Indeed, as a result of prolonged exposure to high temperatures (200° C. or even higher) the highly viscous silicone oils gradually harden over time, until they become inoperable and must be replaced. Also, the Applicant noted that the thermal instability of the highly viscous silicone oils becomes more evident as the viscosity of the silicone oil increases.

Thus, the Applicant faced the problem to provide a highly viscous fluid that can be used as damping fluid and that does not suffer from the defects of the highly viscous silicone oils, in particular of the thermal instability.

In particular, the Applicant faced the problem to provide a highly viscous fluid that retains its viscous properties over the whole application temperature range and that has shelf-life longer than silicone oils, even after exposure at temperatures of 200° C. or higher.

The Applicant has surprisingly found that (per)fluoropolyether (PFPE) polymers having high viscosity are thermally stable and do not harden on exposure at temperatures of 200° C. or even higher.

Thus, in a first aspect, the present invention relates to the use of (per)fluoropolyether copolymers [polymer (P)] having a viscosity higher than 2,000 mm²/s as damping fluids, wherein the viscosity is measured at 20° C. according to standard methods, such as ASTM D445, or with a dynamical mechanical spectrometer Anton Paar MCR 502 rheometer equipped with parallel plates 25 mm, at 1 rad/s and at 25° C.

In a second aspect, the present invention relates to a method for counteract vibrations and/or shocks in a device, said method comprising providing comprising providing an apparatus comprising a damper device, said damper device comprising at least one (per)fluoropolyether copolymers [polymer (P)] having a viscosity higher than 2,000 mm²/s (measured at 20° C. according to standard methods, such as ASTM D445).

### DESCRIPTION OF EMBODIMENTS

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “(per)fluoropolyether” and, when used as substantive, is intended to mean either the singular or the plural from, depending on the context;
the prefix “(per)” in the terms “(per)fluoropolyether” and “(per)fluorovinylethers” means that the polyether or the vinylether can be fully or partially fluorinated;
the term “olefin” is intended to mean an unsaturated hydrocarbon containing at least one carbon-carbon double bond;
the term “damping” is intended to indicate any method of dispersing energy in a vibrating system;
the expression “damping fluid” is intended to indicate a method of dispersing energy in a vibrating system using a fluid having suitable properties, such as in particular viscosity and thermal stability.

Polymer (P) preferably comprises recurring units derived from (per)fluoropolyether and recurring units derived from at least one olefin.

More preferably, said polymer (P) is a block copolymer, i.e. a linear polymer comprising a first portion consisting of recurring units derived from (per)fluoropolyether and a second portion consisting of recurring units derived from at least one olefin, wherein said first portion and said second portion are covalently bonded, typically by means of a bond —C—C— or —O—C—.

In a preferred embodiment, polymer (P) complies with the following structural formula (I):

T-O-[A-B]_{z}-[A-B′]_{z′}-A-T′ (I)

wherein:
A is —(X)ₐ—O—(R_{f})—(X′)_{b}— in which
(R_{f}) is a fully or partially fluorinated polyoxyalkylene chain, X and X′, equal to or different from each other, are selected from
—CF₂—, —CF₂CF₂— and —CF(CF₃)—;
a and b, equal to or different from each other, are integers equal to 0 or 1 with the proviso that the block A linked to the end group T-O— has a=1 and the block A linked to the end group T′ has b=0;
B and B′, identical or different each other, are recurring units derived from at least one olefin having 2 to 10 carbon atoms, optionally comprising at least one halogen atom and optionally comprising at least one heteroatom;
z is an integer higher than or equal to 2;
z′ is 0 or an integer higher than or equal to 1; with the proviso that z and z′ are such that the number average molecular weight of formula (I) is in the range 500-500,000, preferably 1,000-400,000, more preferably 5,000-300,000;
T and T′, equal to or different from each other, are hydrogen atom or a group selected from —CF₂H, —CF₂CF₂H, —CF₃, —CF₂CF₃, —CF₂CF₂CF₃, —CF₂Cl, —CF₂CF₂Cl, —C₃F₆Cl, —CF₂Br.

Preferably, said chain (R_{f}) comprises, preferably consists of, repeating units R°, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)_{w}—CFZ—O— wherein w is an integer from 0 to 3 and Z is a group of general formula —O—R_{(f-a)}—Y, wherein R_{(f-a)} is a fluoropolyoxyalkene chain comprising a number of repeating units from 0 to 10, said recurring units being chosen among the followings: —CFXO—, —CF₂CFXO—, —CF₂CF₂CF₂O—, —CF₂CF₂CF₂CF₂O—, with each of each of X being independently F or CF₃ and Y being a C₁-C₃ perfluoroalkyl group.

Preferably, chain (R_{f}) complies with the following formulae (R_{f}-I) and (R_{f}-II):

—[(CFX¹O)_{g1}(CFX²CFX³O)_{g2}(CF₂CF₂CF₂O)_{g3}(CF₂CF₂CF₂CF₂O)_{g4}]— (R_{f}-I)

wherein
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently ≧0, such that g1+g2+g3+g4 is in the range from 2 to 300, preferably from 10 to 250, even more preferably from 15 to 200; should at least two of g1, g2, g3 and g4 be different from zero, the different recurring units are generally statistically distributed along the chain;

—[(CFX¹O)_{g1}(CFX²CFX³O)_{g2}(CF₂CF₂CF₂O)_{g3}(CF₂CF₂CF₂CF₂O)_{g4}—(CF(CF₃)O)_{g5}(CF₂CF(CF₃)O)_{g6}]— (R_{f}-II)
wherein
X¹, X², X³ are as defined above;
g1, g2, g3, g4, g5 and g6, equal or different from each other, are independently ≧0, such that g1+g2+g3+g4+g5+g6 is in the range from 2 to 300, preferably from 10 to 250, with the proviso that at least one of g5 and g6 are different from 0.

In a preferred embodiment, chain (R_{f}) complies with formula (R_{f}-I) above.

Preferably, X and X′, equal to or different from each other, are selected from —CF₂— and —CF₂CF₂—.

Preferably, B complies with formula (B-1)

—[(CR₁R₂—CR₃R₄)ⱼ(CR₅R₆—CR₇R₈)_{j′}]— (B-1)

in which
j is from 1 to 50,
j′ is from 0 to 50,
R₁, R₂, R₃, R₄, R₅, R₆, R₇, R₈, equal to or different from each other, are selected from hydrogen, halogen, preferably F, Cl; C₁-C₆ (per)haloalkyl, C₁-C₆ alkyl, optionally containing at least one heteroatom selected from O, N, S; and C₁-C₆ oxy(per)fluoroalkyl.

Preferably, B′ complies with formula (B-1), with the proviso that at least one of the substituents R₁ to R₈ is different than in B, and (j+j′) being higher than or equal to 2 and lower than 5.

Generally, the total weight of B and B′ is lower than 50 wt. % based on the total weight of polymer (P), preferably lower than 40 wt. %, more preferably lower than 30 wt. %.

More preferably, B and B′ are recurring units derived from an olefin selected from tetrafluoroethylene (TFE), ethylene (E), vinylidene fluoride (VDF), chlorotrifluoroethylene (CTFE), hexafluoropropene (HFP), (per)fluorovinylethers, and/or propylene (P).

In a preferred embodiment, B and B′ are recurring units derived from tetrafluoroethylene (TFE), hexafluoropropene (HFP) and/or (per)fluorovinylethers.

Preferred (per)fluorovinylethers are those of formula

CF₂═CFOR_{f1},

wherein R_{f1} is selected from:
(a) —CF₃, —C₂F₅, and —C₃F_{7—}, namely, perfluoromethylvinylether (PMVE of formula CF₂═CFOCF₃), perfluoroethylvinylether (PEVE of formula CF₂═CFOC₂F₅), perfluoropropylvinylether (PPVE of formula CF₂═CFOC₃F₇), and mixtures thereof;
(b) —C—F₂OR_{f2}, wherein R_{f2} is a linear or branched C₁-C₆ perfluoroalkyl group, cyclic C₅-C₈ perfluoroalkyl group, a linear or branched C₂-C₈ perfluoroxyalkyl group; preferably, R_{f2} is —CF₂CF₃ (MOVE1), —CF₂CF₂OCF₃ (MOVE2), or —CF₃ (MOVE3).

Preferably, T and T′, equal to or different from each other, are hydrogen atom or a group selected from —CF₃, —CF₂CF₃, —CF₂CF₂CF₃, —CF₂Cl, —CF₂CF₂Cl.

The viscosity of polymer (P) can be measured using different methods depending on the viscosity of polymer (P) itself. The viscosity of polymers P according to the present invention was measured as described above.

Preferably, said polymer (P) has a viscosity higher than 2,500 mm²/s at 20° C., more preferably higher than 3,000 mm²/s at 20° C. and even more preferably higher than 5,000 mm²/s at 20° C.

Preferably, said polymer (P) has a viscosity lower than 2,500,000 mm²/s at 20° C., more preferably lower than 2,000,000 mm²/s at 20° C., and even more preferably lower than 1,500,000 mm²/s at 20° C.

Preferably, said polymer (P) has a viscosity of from 5,000 to 1,500,000 mm²/s at 20° C., more preferably of from 5,500 to 1,000,000 mm²/s at 20° C. and even more preferably of from 6,000 to 950,000 mm²/s at 20° C.

Polymer (P) can be prepared by means of known processes, for example as disclosed in WO 2008/065163 (SOLVAY SOLEXIS S.P.A.) or via supercritical fluid fractionation.

Advantageously, polymer (P) is used as damping fluids in damping devices that are used in applications wherein high pressures, high work-loads and high temperatures are involved. However, the skilled person will easily understand that the use of polymer (P) at moderate or low work-loads and/or temperature and/or pressure may also be advantageous.

Preferably, damper devices are selected in the group comprising dash pots; shock absorbers such as twin-tube or mono-tube shocks absorbers, positive sensitive damping (PSD) shock absorbers, acceleration sensitive damping (ASD); rotary dampers; tuned mass dampers; viscous couplings; viscous fan clutches and torsional viscous dampers.

Typical apparatus wherein the damper devices can be used are selected in the group comprising: mechanical or electric device for wheeled vehicles (such as suspensions installations, carburetors, internal combustion devices, engines, transmissions, crankshafts), for work boats (such as engines), for aircrafts and spacecraft (such as aircraft carrier decks), for power transmission lines, for wind turbine, for consumer electronics (such as mobile phones and personal computers), for off-shore rig, for oil & gas distribution systems (such as pumps); compressors (such as reciprocating compressors for gas pipelines); devices for buildings and civil structures (such as bridges, towers, elevated freeways).

Polymer (P) can be used either alone or in admixture with another PFPE polymer having high viscosity [polymer (P*)] and/or suitable further ingredients.

Preferably, polymer (P) is used as ingredient in a composition, said composition further comprising another PFPE polymer having high viscosity [polymer (P*)] and/or suitable further ingredients.

Preferably, said polymer (P*) has a viscosity value as those disclosed above for polymer (P).

Said polymer (P*) complies with formula (I) disclosed above for polymer (P). Also, the viscosity of polymer (P*) is as disclosed above for polymer (P). However, when used in admixture, polymer (P) and polymer (P*) differ in their structural formula and/or viscosity.

Suitable further ingredients include, but are not limited to, metal suphides, graphite, talcum, mica, clay, silica, fatty acid esters, metal oxides, hydroxides, etc. preferably in the form of fine particles having a particle size of from 1 to 1000 μm; corrosion inhibitors; anti-oxidants; anti-rust agents; anti-wear agents; tackifiers; wetting agents; polymeric particles such as polytetrafluoroethylene (PTFE) and fluorinated additives.

Suitable ingredients also comprise polarizable solid particles. Advantageously, when said polarizable solid particles are dispersed in an electrically non-conducting hydrophobic liquid such as polymer (P), a suspension can be obtained that exhibits peculiar rheological properties under the influence of an electrical field. In particular, these suspensions show a dramatic increase in viscosity and modulus with applied voltage, in some cases literally being transformed from a liquid to a virtual solid upon the application of the electric field. This change is reversible and typically takes place in a matter of milliseconds. As it is known in the art, materials which exhibit this phenomenon are generally called electro-rheological (ER) or electroviscous (EV) fluids and can be used in mechanical damping applications.

Examples of solid particles include acid group-containing polymers, silica gel, starch, electronic conductors, zeolite, sulphate ionomers of aminofunctional siloxanes, organic polymers containing free salified acid groups, organic polymers containing at least partially “salified” acid groups, homo-polymers of monosaccharides or other alcohols, copolymers of monosaccharides or other alcohols and copolymers of phenols and aldehydes or mixtures thereof.

Should the disclosure of any patents, patent applications and publications which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### EXPERIMENTAL SECTION

Materials

Tetrafluoroethylene (TFE), hexafluoropropylene (HFP), perfluoromethyl-vinyl-ether (PMVE), 2,2,24-trifluoro-5-trifluoro methoxy-1,3-dioxole (TTD) and Galden® HT230 was obtained by Solvay Specialty Polymers Italy S.p.A.

(C1) —PSF-5,000 mm²/s Silicone Damping Fluid—polydimethylsiloxane fluid having kinematic viscosity of 5,300 mm²/s at 20° C. was obtained by Clearco.
(C2) —BLUESIL™ FLD 47v60 000—polydimethylsiloxane fluid having kinematic viscosity of 60,000 mm²/s at 20° C. was obtained by Bluestar Silicones.

Methods

¹⁹F-NMR—Varian Mercury 200 MHz spectrometer working for the ¹⁹F nucleus was used to obtain the structure, molecular weight end composition of the PFPE oils reported in the following examples. The ¹⁹F-NMR spectrum was obtained on pure samples using CFCl₃ as internal reference.

Determination of the Peroxidic Content (PO): the analysis of the peroxide content was carried out by iodometric titration using a Mettler® DL 40 device equipped with platinum electrode.

Determination of the Residual Acidity: the acidity content was determined by potentiometric titration with Mettler® DL 40 device equipped with DG 115-SC type electrode. The titration was made using aqueous solution NaOH 0.01 M as titrating agent.

The kinematic viscosity at a given temperature was evaluated according to ASTM D445 using a Cannon-Fenske capillary viscosimeter.

The thermal transitions were determined with the Perkin Elmer® DSC-2C instrument.

### Example 1

Polymer (P1) containing segments from TFE was prepared with a batch thermal process in a 100 litres glass reactor as follows.

The reactor was equipped with thermostatic control of the temperature, mechanical stirring, bubbling inlet for the feeding of nitrogen and tetrafluoroethylene (TFE). 80 kg of Galden® HT230 were introduced into the reactor, together with 20 kg of a peroxidic perfuoropolyether (PFPE) of formula

TO—(CF₂O)ᵣ(CF₂CF₂O)ₛ(O)ₜ-T′

wherein T and T′ were —CF₃ (43%), —CF₂Cl (5%), —CF₂CF₂Cl (4%), —COF (2%), and —CF₂COF (46%), having number average molecular weight (Mn) equal to 30000, s/r=1.17 and a PO equal to 1.46%.

The reaction mixture was heated up to 170° C. under stirring and under nitrogen flow (50 Nl/h). As the temperature was reached, the nitrogen feed was stopped and a flow rate of TFE started at 50 Nl/h.

The mixture was maintained under stirring using the follow temperature program:
170° C. for 1.5 hours
180° C. for 1.5 hours
190° C. for 1.5 hours
200° C. for 1.5 hours
210° C. for 1 hour.

The ratio between the TFE moles and the moles of peroxidic units fed was equal to 1.0. The TFE feeding was then interrupted and the feeding of nitrogen was set at 50 Nl/h. The temperature was raised up to 230° C. and maintained constant for 5 hours.

At the end of the thermal treatment the mixture was let cool down to 180° C.

While maintaining the reaction mixture under stirring at 180° C., nitrogen flow was closed and 8 Nl/h of fluorine gas was passed for a total 24 hours. At the end of the fluorination, always under stirring, nitrogen (70 Nl/h) was fed for degassing the product and the equipment. After 6 hours, the mixture was let cool down to room temperature.

The resulting mixture was a clearly, homogeneous solution. The oil was recovered by using the thin film distillation under vacuum, operating at 230° C. at 10⁻² hPa.

Galden® HT230 was then removed, obtaining 15 kg of high viscous fluid which was characterized. The product obtained was subjected to acidity and PO measurement, which resulted lower than the sensitivity limit of the methods.

¹⁹F-NMR analysis confirm the following structure:

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 0.91;
g3 and g4 were 3.6 and 3.9, respectively;
B was —(CF₂)_{y}— with the y average length of 9.7;
q was 5.7;
the percentage of —(BO)_{q}— in the final polymer was 10% by weight based on the total weight of the polymer;
T and T′ were mainly —CF₃ (91%) and the remaining part (9%) was —CF₂Cl and —CF₂CF₂Cl.

Polymer (P1) had the following properties:

number average molecular weight (Mn) equal to 29000;
kinematic viscosity 12000 mm²/s (measured at 20° C.); and
DSC analysis showed a T_{g} equal to −115° C. and did not show any melting peak.

### Example 2

Polymer (P2) containing segments from TFE was prepared with a batch thermal process in a 160 liters nickel reactor as follows.

The reactor was equipped with electrical resistances for the temperature control, mechanical stirring, bubbling inlet for the gas feeding (nitrogen, TFE and fluorine). 145 kg of Galden® HT230 were introduced into the reactor, together with 50 kg of a peroxidic perfuoropolyether (PFPE) of formula:

TO—(CF₂O)ᵣ(CF₂CF₂O)ₛ(O)ₜ-T′

wherein T and T′ were —CF₃ (47%), —CF₂Cl (3%), —CF₂CF₂Cl (2%) and —CF₂COF (48%), having number average molecular weight (Mn) equal to 26000, s/r=1.10 and a PO equal to 1.36%.

The reaction mixture was heated following the procedure and using the temperature program disclosed in Example 1 above.

The TFE feeding was then interrupted and the feeding of nitrogen was set at 80 Nl/h. The temperature was raised up to 230° C. and maintained constant for 5 hours.

At the end of the thermal treatment the mixture was let cool down to 180° C. Then, the same procedure disclosed in Example 1 above was performed, but the fluorine flow was set at 10 Nl/h and then the nitrogen flow was set at 80 Nl/h. After 6 hours, the mixture was let cool down to room temperature.

The resulting mixture was a clearly, homogeneous solution. The oil was recovered following the procedure disclosed in Example 1 above.

Galden® HT230 was also removed, obtaining 37 kg of high viscous fluid which was characterized. The product obtained was subjected to acidity and PO measurement, which resulted lower than the sensitivity limit of the methods.

¹⁹F-NMR analysis confirm the following structure

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 1.07,
g3 and g4 were 2.6 and 3.2, respectively;
B was —(CF₂)_{y}—, with the y average length of 8.9;
q was 3.3;
the percentage of —(BO)_{q}— in the final polymer was 6.8% by weight based on the total weight of the polymer; and
T and T′ were —CF₃ (95%) and the remaining part (5%) was —CF₂Cl and —CF₂CF₂Cl.

Polymer (P1) had the following properties:

number average molecular weight (Mn) equal to 24000;
kinematic viscosity (measured at 20° C.) 6200 mm²/s.

### Example 3

Polymer (P3) containing segments from TFE and HFP was prepared with a batch thermal process in a 500 milliliters glass reactor as follows.

The reactor was equipped with a bath for control of the temperature, magnetic stirring, bubbling inlet for the feeding of nitrogen and TFE. 480 g of Galden® HT230 were introduced into the reactor together with 120 kg of a peroxidic perfuoropolyether (PFPE) of formula:

TO—(CF₂O)ᵣ(CF₂CF₂O)ₛ(O)ₜ-T′

wherein
T and T′ were —CF₃ (19%), —CF₂Cl (17%), —CF₂CF₂Cl (15%) and —CF₂COF (49%), having number average molecular weight (Mn) equal to 41000,
s/r=1.20 and a PO equal to 1.17%.

The reaction mixture was heated up to 170° C. under stirring and under nitrogen flow (5 Nl/h). As the temperature was reached, the nitrogen feed was stopped and TFE and HFP were fed by the same bubbling inlet (the flow-rate of TFE was 0.5 Nl/h and of HFP was 5.0 Nl/h).

The mixture was then maintained under stirring using the follow temperature program:
170° C. for 1 hour;
180° C. for 1 hour;
190° C. for 1 hour;
200° C. for 1 hour.

The feeding of TFE and HFP was then interrupted and the feeding of nitrogen was set at 5 Nl/h. The temperature was raised up to 230° C. and maintained constant for 5 hours.

At the end of the thermal treatment the mixture was let cool at room temperature.

The solution was then fluorinated under stirring at 180° C. by passing 1 Nl/h of fluorine gas for a total of 24 hours. At the end of the fluorination, nitrogen (5 Nl/h) was fed for 5 hours at 180° C. for degassing the product and the equipment. After that, the mixture was let cool down to room temperature.

The oil was recovered following the procedure disclosed in Example 1 above.

Galden® HT230 was then removed, obtaining 121 g of high viscous fluid which was characterized. The product obtained was subjected to acidity and PO measurement, which resulted lower than the sensitivity limit of the methods.

¹⁹F-NMR analysis confirm the following structure:

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 1.02;
g3 and g4 were 1.4 and 2.5 respectively,
B was —(CFX)_{y}— wherein X was —F and —CF₃ and the y average length was 38.4;
q was 2.0;
the percentage of —(BO)_{q}— in the final polymer was 16.5% by weight based on the total weight of the polymer, coming from TFE (6.2% w/w) and HFP (10.3% w/w);
T and T′ were —CF₃ (76%) and the remaining part (24%) was —CF₂Cl and —CF₂CF₂Cl.

Polymer (P3) had the following properties:

number average molecular weight (Mn) equal to 30000;
kinematic viscosity was 21000 mm²/s at 20° C., 8400 mm²/s at 40° C., 1400 mm²/s at 100° C.;
data Viscosity Index was 420, calculated according to ASTM D2270;
DSC analysis showed a T_{g} of −106.3° C. and did not show any melting peak.

### Example 4

Polymer (P4) was prepared by means of a fractionation process with supercritical CO₂.

The process was performed using A SFT-150 supercritical fluid extractor (SFE) available from Supercritical Fluid Technologies, Inc., equipped with a 300 ml fractionation vessel and a heatable restrictor valve.

128 g of the PFPE oil prepared following the procedure of Example 2 above was introduced into the fractionation vessel of the supercritical fluid extractor. The fractionation vessel containing the PFPE oil was heated at 60° C. and the pressure was increased from 10 MPa to 17 MPa, operating at a CO₂ flow rate of 4 Nl/min.

17 g of PFPE oil Fraction 1 (Mn=7100) were recovered.

After recovery of Fraction 1, the pressure was increased from 17 MPa to 19.5 MPa, while the temperature was kept constant at 60° C. and the CO₂ flow was at rate of 4 Nl/min.

26 g of PFPE oil Fraction 2 (Mn=22000) were recovered.

The pressure was increased again from 19.5 MPa to 20 MPa operating at 60° C. and at a CO₂ flow rate of 4 Nl/min.

20 g of PFPE oil Fraction 3 (Mn=36000) were recovered.

The pressure was discharged, the fractionation vessel was cooled down to room temperature and 63 g of the residual product were recovered.

¹⁹F-NMR analysis confirm the following structure:

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 0.97;
g3 and g4 were 6.9 and 8.3, respectively;
B was —(CF₂)_{y}— with the y average length of 8.6;
q was 9.5;
the percentage of —(BO)_{q}— in the final polymer was 7.0% by weight based on the total weight of the polymer;
T and T′ were —CF₃ (82%) and the remaining part (18%) was —CF₂Cl, —CF₂CF₂Cl.

Polymer (P4) had the following properties:

number average molecular weight (Mn) equal to 61000;
kinematic viscosity was 16800 mm²/s at 40° C., 2700 mm²/s at 100° C.;
data Viscosity Index was 452 calculated according to ASTM D2270.

### Example 5

Polymer (P5) was prepared by means of a fractionation process with supercritical CO₂, using the same supercritical fluid extractor used in Example 4 above.

220 g of the PFPE oil prepared following the procedure disclosed in Example 2 were introduced into the fractionation vessel of the supercritical fluid extractor. The fractionation vessel containing the PFPE oil is heated at 60° C. and the pressure was increased from 14 MPa to 17 MPa operating at a CO₂ flow rate of 4 Nl/min.

37 g of PFPE Oil Fraction 1 (Mn=8600) were recovered.

After recovery of Fraction 1, the pressure was increased to 20 MPa, while the temperature and the CO₂ flow rate were kept constant.

67 g of PFPE Oil Fraction 2 with (Mn=26000) were recovered.

After recovery of Fraction 2, the pressure was increased to 21.5 MPa, while the temperature and the CO₂ flow rate were kept constant.

55 g of PFPE Oil Fraction 3 (Mn=41000) were recovered.

The pressure was then discharged, the fractionation vessel was cooled down to room temperature and 60 g of the residual product were recovered.

¹⁹F-NMR analysis confirm the following structure:

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 0.97,
g3 and g4 were 10.6 and 15.5, respectively;
B was —(CF₂)_{y}— with the y average length of 9.8;
q was 11.5;
the percentage of —(BO)_{q}— in the final polymer was 6.1% by weight based on the total weight of the polymer;
T and T′ were —CF₃ (87%) and the remaining part was —CF₂Cl and —CF₂CF₂Cl.

Polymer (P5) had the following properties:

number average molecular weight (Mn) equal to 95000;
kinematic viscosity was about 60000 at 20° C., 39500 mm²/s at 40° C. and 4840 mm²/s at 100° C.;
the data Viscosity Index 449 was calculated with ASTM D2270.

### Example 6

Polymer (P6) containing segments from TFE and HFP was prepared with a batch thermal process in a 160 litres nickel reactor as follows.

The reactor was equipped with electrical resistances for the control of the temperature, mechanical stirring, bubbling inlet for the feeding of the gases, i.e. nitrogen, TFE, HFP and fluorine. 140 kg of Galden® HT230 were introduced into the reactor, together with 30 kg of a peroxidic perfuoropolyether (PFPE) of formula:

TO—(CF₂O)ᵣ(CF₂CF₂O)ₛ(O)ₜ-T′

wherein T and T′ were —CF₃ (42%), —CF₂Cl (11%), —CF₂CF₂Cl (7%) and —CF₂COF (40%), having number average molecular weight (Mn) equal to 40100, s/r=1.09 and a PO equal to 1.25%.

The reaction mixture was heated up to 160° C. under stirring and under nitrogen flow (5 Nl/h). As the temperature was reached, the nitrogen feed was stopped and TFE and HFP were fed by the same bubbling inlet. The flow-rate of TFE was 40 Nl/h and the flow rate of HFP was 33 Nl/h.

The mixture was then maintained under stirring using the follow temperature program:
160° C. for 1.0 hour
165° C. for 3.0 hours
170° C. for 3.0 hours
175° C. for 3.0 hours
180° C. for 2.0 hours
185° C. for 1.0 hour
190° C. for 1.0 hour
195° C. for 1.0 hour
200° C. for 1.0 hour.

The TFE feeding was then interrupted and the feeding of nitrogen was set at 50 Nl/h. The temperature was raised up to 230° C. and maintained constant for 15 hours.

At the end of the thermal treatment the mixture was let cool down to 180° C.

Then, the same procedure disclosed in Example 1 above was performed, but the flow of the fluorine gas was set at 10 Nl/h and at the end of the fluorination, the nitrogen flow was set at 50 Nl/h. After 24 hours, the mixture was let cool down to room temperature.

The resulting mixture was a clearly, homogeneous solution. The oil was recovered following the procedure disclosed in Example 1 above.

Galden® HT230 was then removed, obtaining 28 kg of high viscous fluid which was characterized. The product obtained was subjected to acidity and PO measurement, which resulted lower than the sensitivity limit of the methods.

¹⁹F-NMR analysis confirm the following structure

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 0.89;
g3 and g4 were 1.9 and 3.0, as average, respectively,
B was —(CFX)_{y}— wherein X was —F and —CF₃ and the y average length was 12.5;
q was 6.6;
the percentage of —(BO)_{q}— in the final polymer was 15.3% by weight based on the total weight of the polymer, coming from TFE (10.5% w/w) and HFP (4.9% w/w);
T and T′ were —CF₃ (83%) and the remaining part (17%) was —CF₂Cl and —CF₂CF₂Cl.

Polymer (P6) had the following properties:

number average molecular weight (Mn) equal to 30200;
kinematic viscosity 18500 mm²/s (measured at 25° C.).

### Example 7

Polymer (P7) was prepared by means of a fractionation process with supercritical CO₂.

The process was performed using a pilot units for supercritical fluid extractions (SFE) available from SITEC-Sieber Engineering AG., equipped with a 2 litres fractionation vessel.

1.43 kg of the PFPE oil prepared following the procedure disclosed in Example 6 were introduced into the fractionation vessel of the supercritical fluid extractor. The fractionation vessel containing the PFPE oil was heated at 60° C. and the pressure was increased to 17 MPa, operating at a CO₂ flow rate of 4.5 kg/h.

351 g of PFPE Oil Fraction 1 (Mn=12000) were recovered.

After recovery of Fraction 1, the pressure was increased from 17 MPa to 20 MPa, while the temperature and the CO₂ flow rate were kept constant.

349 g of PFPE Oil Fraction 2 with (Mn=32000) were recovered.

The fractionation vessel was then discharged and 703 g of the residual product were recovered.

¹⁹F-NMR analysis confirm the following structure:

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 0.87,
g3 and g4 were 2.7 and 5.1, respectively;
B was —(CFX)_{y}— wherein X was —F and —CF3 and the y average length was 14.6;
q was 8.4;
the percentage of —(BO)_{q}— in the final polymer was 16.0% by weight based on the total weight of the polymer, coming from TFE (10.7% w/w) and HFP (5.3% w/w);
T and T′ were —CF₃ (90%) and the remaining part (10%) was —CF₂Cl and —CF₂CF₂Cl.

Polymer (P7) had the following properties:

number average molecular weight (Mn) equal to 43000;
kinematic viscosity was 130000 mm²/s at 25° C.

### Example 8

Polymer (P8) was prepared by means of a fractionation process with supercritical CO₂.

The process was performed using a pilot units for supercritical fluid extractions (SFE) available from SITEC-Sieber Engineering AG., equipped with a 2 litres fractionation vessel.

1.40 kg of the PFPE oil prepared following the procedure disclosed in Example 6 were introduced into the fractionation vessel of the supercritical fluid extractor. The fractionation vessel containing the PFPE oil was heated at 60° C. and the pressure was increased to 18 MPa operating at a CO₂ flow rate of 4.8 kg/h.

560 g of PFPE Oil Fraction 1 (Mn=15800) were recovered.

After recovery of Fraction 1, the pressure was increased to 21 MPa, while the temperature and the CO₂ flow rate were kept constant.

280 g of PFPE Oil Fraction 2 with (Mn=42500) were recovered.

After recovery of Fraction 2, the pressure was increased to 22 MPa, while the temperature and the CO2 flow rate were kept constant.

143 g of PFPE Oil Fraction 3 (Mn=53600) were recovered.

The fractionation vessel was then discharged and 416 g of the residual product were recovered.

¹⁹F-NMR analysis confirm the following structure:

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 0.88,
g3 and g4 were 4.6 and 10.4, respectively;
B was —(CFX)_{y}— wherein X was —F and —CF3 and the y average length was 14.2;
q was 16.8;
the percentage of —(BO)_{q}— in the final polymer was 15.7% by weight based on the total weight of the polymer, coming from TFE (10.2% w/w) and HFP (5.5% w/w);
T and T′ were —CF₃ (89%) and the remaining part (11%) was —CF₂Cl and —CF₂CF₂Cl.

Polymer (P8) had the following properties:

number average molecular weight (Mn) equal to 86000;
the rheological properties were measured with the dynamic mechanical spectrometer Anton Paar MCR 502 rheometer (Parallel Plates 25 mm) with a dynamic frequency sweep test; the value of complex viscosity measured at 1 rad/s and 25° C. was 777 Pa*s.

### Example 9

The syntheses of polymer (P9) containing segments from TFE and HFP were carried out using a photochemical procedure.

A 300 ml reactor was equipped with one UV lamp (HANAU type TQ150) and was provided with magnetic stirring, adjustable cooling system, thermocouple, inlet tubes for addition of nitrogen, TFE and HFP.

420 g of Galden® HT230 were introduced into the reactor together with 100 g of a peroxidic perfuoropolyether (PFPE) of formula:

TO—(CF₂O)ᵣ(CF₂CF₂O)ₛ(O)ₜ-T′

wherein T and T′ were —CF₃ (45%), —CF₂Cl (13%), —CF₂CF₂Cl (7%) and —CF₂COF (35%), having number average molecular weight (Mn) equal to 41500, s/r=1.09 and a PO equal to 1.26%.

The reactor was cooled at about 10° C. under stirring in nitrogen atmosphere. As the temperature was reached, the UV lamp was switched on and the fluorinated monomers (HFP and TFE) were feed by the same inlet (the flow-rate of TFE was 0.6 Nl/h and the flow rate of HFP was 1.2 Nl/h).

The mixture was then maintained at the same conditions for 6 hours. Then, the UV lamp was switched off and the feeding of TFE and HFP was interrupted. The temperature was raised up to room temperature (RT) under nitrogen flow.

The resulting mixture was transferred into a second glass reactor, treated at 230° C. for 5 hours and then fluorinated at 180° C. with 1 Nl/h of fluorine gas for a total of 24 hours.

The oil was recovered after vacuum distillation of the solvent (Galden® HT230). 101 g of a high viscous fluid were obtained and characterized.

The product was subjected to acidity and PO measurement, which resulted lower than the sensitivity limit of the methods.

¹⁹F-NMR analysis confirm the following structure:

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 0.92;
g3 and g4 were 1.7 and 2.2 respectively;
B was —(CFX)_{y}— wherein X was —F and —CF3 and the y average length was 14.4;
q was 4.9;
the percentage of —(BO)_{q}— in the final polymer was 10.5% by weight based on the total weight of the polymer, coming from TFE (5.7% w/w) and HFP (4.8% w/w);
T and T′ were —CF₃ (81%) and the remaining part (19%) was —CF₂Cl and —CF₂CF₂Cl.

Polymer (PY1) had the following properties:

number average molecular weight (Mn) equal to 39900;
kinematic viscosity was 112000 mm²/s at 25° C.

### Example 10

The syntheses of polymer (P10) containing segments from TFE and PMVE were carried out by using the same photochemical apparatus used in Example 9 above.

420 g of Galden® HT230 were introduced into the reactor together with 100 g of a peroxidic perfuoropolyether (PFPE) of formula:

TO—(CF₂O)ᵣ(CF₂CF₂O)ₛ(O)ₜ-T′

wherein T and T′ were —CF₃ (45%), —CF₂Cl (13%), —CF₂CF₂Cl (7%) and —CF₂COF (35%), having number average molecular weight (Mn) equal to 41500, s/r=1.09 and a PO equal to 1.26%.

The reactor was cooled at about 10° C. under stirring in nitrogen atmosphere. As the temperature was reached, the UV lamp was switched on and the fluorinated monomers (PMVE and TFE) were feed by the same inlet (the flow-rate of TFE was 1.8 Nl/h and of PMVE was 1.0 Nl/h).

The mixture was then maintained in these conditions for 6 hours. Then, the UV lamp was switched off and the feeding of TFE and PMVE was interrupted. The temperature was raised up to RT under nitrogen flow.

The resulting mixture was transferred into a second glass reactor, treated at 230° C. for 5 hours and then fluorinated at 180° C. with 1 Nl/h of fluorine gas for a total of 24 hours.

The oil was recovered after vacuum distillation of the solvent (Galden® HT230). 106 g of high viscous fluid were obtained and characterized.

The product was subjected to acidity and PO measurement, which resulted lower than the sensitivity limit of the methods.

¹⁹F-NMR analysis confirm the following structure

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 0.91;
g3 and g4 were 2.4 and 2.3 respectively,
B was —(CFX)_{y}— wherein X was —F and —OCF₃ and the y average length was 27.0;
q was 5.0;
the percentage of —(BO)_{q}— in the final polymer was 19.2% by weight based on the total weight of the polymer, coming from TFE (10.8% w/w) and PMVE (8.4% w/w);
T and T′ were —CF₃ (81%) and the remaining part (19%) was —CF₂Cl and —CF₂CF₂Cl.

Polymer (P10) had the following properties:

number average molecular weight (Mn) equal to 42800;
the value of complex viscosity at 1 rad/s and 25° C. was 336 Pa*s (dynamic frequency sweep test performed on Anton Paar MCR 502 rheometer with parallel plates 25 mm.

### Example 11

The syntheses of polymer (P11) containing segments from TFE and TTD was carried out by using the some photochemical apparatus used in Example 9 above.

400 g of Galden® HT230 were introduced into the reactor together with 104 g of a peroxidic perfuoropolyether (PFPE) of formula:

TO—(CF₂O)ᵣ(CF₂CF₂O)ₛ(O)ₜ-T′

wherein T and T′ were —CF₃ (45%), —CF₂Cl (13%), —CF₂CF₂Cl (7%) and —CF₂COF (35%), having number average molecular weight (Mn) equal to 41500, s/r=1.09 and a PO equal to 1.26%.

The reactor was cooled to about 10° C. under stirring in nitrogen atmosphere. As the temperature was reached, 53 g of TTD were added into the reactor and mixed for one hour. Then, the UV lamp is switched on and TFE was feed at a flow-rate of 1.2 Nl/h.

The mixture was then maintained in these conditions for 6 hours. Then, the UV lamp was switched off and the feeding of TFE was interrupted. The temperature was raised up to RT under nitrogen flow.

The resulting mixture was transferred into a second glass reactor, treated at 230° C. for 5 hours, fluorinated at 180° C. with 1 Nl/h of fluorine gas for a total of 24 hours.

The oil was recovered after vacuum distillation of the solvent (Galden® HT230). 109 g of high viscous fluid was obtained and characterized.

The product was subjected to acidity and PO measurement, which resulted lower than the sensitivity limit of the methods.

¹⁹F-NMR analysis confirm the following structure

TO—(CF₂O)_{g1}(CF₂CF₂O)_{g2}(CF₂CF₂CF₂O)_{g3}(CF₂CF₂CF₂CF₂O)_{g4}(BO)_{q}-T′

wherein
the ratio g2/g1 was 1.16;
g3 and g4 were 2.5 and 2.5 respectively,
B was —(C₂F₄)_{y1}(TDD)_{y2} coming respectively from TFE and TDD, with the ratio y1/y2 being of 0.26;
the percentage of —(BO)_{q}— in the final polymer was 28.7% by weight based on the total weight of the polymer, coming from TFE (3.1% w/w) and TTD (25.5% w/w);
T and T′ were —CF₃ (82%) and the remaining part (18%) was —CF₂Cl and —CF₂CF₂Cl.

Polymer (P11) had the following properties:

number average molecular weight (Mn) equal to 46300;
kinematic viscosity was 8900 mm²/s at 25° C.

### Example 12—Thermal Stability Test

The thermal stability test was carried out at 230° C. on polymer (P2) prepared following the procedure disclosed in Example 2 above and on comparative high viscosity polydimethylsiloxane fluid PSF (hereinafter referred to as polymer C1) by Clearco.

25 ml of each of polymer (P2) and polymer (C1) were poured into 100 ml glass vessels and stirred at 230° C.

After 5 hours, the sample containing comparison polymer (C1) was analysed by visual inspection and was found to be in the form of a gel. The sample was then left cool to room temperature and analysed again. The sample was found to be a solid gum.

After 48 hours, the sample containing polymer (P2) was analysed by visual inspection and the sample was found to be still liquid (no gelification was observed). Also, its kinematic viscosity at 20° C. was unchanged (6200 mm²/s).

### Example 13—Thermogravimetric Analysis (TGA)

Thermogravimetric analysis on samples of the polymers prepared as described above was performed in order to evaluate their thermal stability. The procedure was according to ASTM E2550-11, measuring the temperatures at which a loss of 1%, 2%, 10% and 50% of the weight of the samples occurred.

The results are summarized in the following Table 1:

TABLE 1

| | | T ° C. | T ° C. | T ° C. | T ° C. | |
|---|---|---|---|---|---|---|
| | Viscosity | loss | loss | loss | loss | |
| Sample | (mm²/s) | 1% | 2% | 10% | 50% | Residue |
| P5 | 60,000 at | 445 | 455 | 476 | 503 | none |
| | 20° C. | | | | | |
| Fomblin ® | 1,500 at | 373 | 389 | 434 | 483 | none |
| M (*) | 20° C. | | | | | |
| Fomblin ® | 2,500 at | 370 | 386 | 426 | 478 | none |
| Y (*) | 20° C. | | | | | |
| C2 (*) | 60,000 at | 189 | 286 | 389 | 491 | 20.7 |
| | 25° C. | | | | | |

(*) Comparison

The above data showed that the polymer (P5) according to the present invention was more stable to high temperature than the polymers used as comparison, i.e. non-functionalized Fomblin®M PFPE and Fomblin®Y PFPE and the high viscosity polydimethylsiloxane fluid PSF (C2).

1. A method for counteracting vibrations and/or shocks in a device, said method comprising providing an apparatus comprising a damper device, said damper device comprising at least one (per)fluoropolyether copolymer [polymer (P)] having a viscosity higher than 2,000 mm²/s and comprising recurring units derived from (per)fluoropolyether and recurring units derived from at least one olefin,
the viscosity being measured at 20° C. according to standard method ASTM D445, or with a dynamic mechanical spectrometer Anton Paar MCR 502 rheometer equipped with parallel plates 25 mm, at 1 rad/s and at 25° C.

2. The method according to claim 1, wherein said damper device is selected from dash pots; shock absorbers such as twin-tube or mono-tube shocks absorbers, positive sensitive damping (PSD) shock absorbers, acceleration sensitive damping (ASD); rotary dampers; tuned mass dampers; viscous couplings; viscous fan clutches and torsional viscous dampers.

3. The method according to claim 1, wherein said apparatus is selected from mechanical or electric devices for wheeled vehicles, for work boats, for aircrafts and spacecraft, for power transmission lines, for wind turbine, for consumer electronics, for off-shore rig, or for oil & gas distribution systems; compressors; and devices for buildings and civil structures.

4. The method according to claim 1, wherein polymer (P) is a block copolymer comprising a first portion consisting of recurring units derived from (per)fluoropolyether and a second portion consisting of recurring units derived from at least one olefin, wherein said first portion and said second portion are covalently bonded.

5. The method according to claim 1, wherein polymer (P) complies with structural formula (I):
T-O-[A-B]_{z}[A-B′]_{z′}-A-T′ (I)
wherein:
A is —(X)ₐ—O—(R_{f})—(X)_{b}— in which
(R_{f}) is a fully or partially fluorinated polyoxyalkylene chain,
X and X′, equal to or different from each other, are selected from —CF₂—, —CF₂CF₂— and —CF(CF₃)—;
a and b, equal to or different from each other, are integers equal to 0 or 1 with the proviso that the block A linked to the end group T-O— has a=1 and the block A linked to the end group T′ has b=0;
B and B′, identical or different each other, are recurring units derived from at least one olefin having 2 to 10 carbon atoms, optionally comprising at least one halogen atom and optionally comprising at least one heteroatom;
z is an integer higher than or equal to 2;
z′ is 0 or an integer higher than or equal to 1; with the proviso that z and z′ are such that the number average molecular weight of formula (I) is in the range 500-500,000;
T and T′, equal to or different from each other, are hydrogen atom or a group selected from —CF₂H, —CF₂CF₂H, —CF₃, —CF₂CF₃, —CF₂CF₂CF₃, —CF₂Cl, —CF₂CF₂Cl, —C₃F₆Cl, —CF₂Br.

6. The method according to claim 5, wherein chain (R_{f}) comprises repeating units R°, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, or H;
(iv) —CF₂CF₂CF₂CF₂O—;
(v) —(CF₂)_{w}—CFZ—O— wherein w is an integer from 0 to 3 and Z is a group of general formula —O—R_{(f-a)}—Y, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of each of X being independently F or CF₃ and Y being a C₁-C₃ perfluoroalkyl group.

7. The method according to claim 6, wherein B complies with formula (B-1)
—[(CR₁R₂—CR₃R₄)ⱼ(CR₅R₆—CR₇R₈)_{j′}]— (B-1)
in which
j is from 1 to 50,
j′ is from 0 to 50,
R₁, R₂, R₃, R₄, R₅, R₆, R₇, R₈, equal to or different from each other, are selected from hydrogen, halogen; C₁-C₆ (per)haloalkyl, C₁-C₆ alkyl, optionally containing at least one heteroatom selected from O, N, S; and C₁-C₆ oxy(per)fluoroalkyl.

8. The method according to claim 1, wherein polymer (P) has a viscosity higher than 2,500 mm²/s at 20° C.

9. The method according to claim 1, wherein polymer (P) has a viscosity lower than 2,500,000 mm²/s at 20° C.

10. The method according to claim 1, wherein polymer (P) has a viscosity of from 5,000 to 1,500,000 mm²/s at 20° C.

11. The method according to claim 1, wherein polymer (P) is an ingredient in a composition, said composition further comprising
another PFPE polymer [polymer (P*)] having a viscosity higher than 2,000 mm²/s at 20° C. and/or
suitable further ingredients.

12. The method according to claim 11, wherein said suitable further ingredients include metal suphides, graphite, talcum, mica, clay, silica, fatty acid esters, metal oxides, hydroxides; corrosion inhibitors; anti-oxidants; anti-rust agents; anti-wear agents; tackifiers; wetting agents; polymeric particles; and polarizable solid particles.

13. A damping fluid comprising a (per)fluoropolyether copolymer [polymer (P)], said polymer (P) having a viscosity higher than 2,000 mm²/s and comprising recurring units derived from (per)fluoropolyether and recurring units derived from at least one olefin, the viscosity being measured at 20° C. according to standard method ASTM D445, or with a dynamic mechanical spectrometer Anton Paar MCR 502 rheometer equipped with parallel plates 25 mm, at 1 rad/s and at 25° C.

14. The damping fluid according to claim 13, wherein polymer (P) is a block copolymer comprising a first portion consisting of recurring units derived from (per)fluoropolyether and a second portion consisting of recurring units derived from at least one olefin, wherein said first portion and said second portion are covalently bonded.

15. The damping fluid according to claim 13, wherein said composition further comprises
another PFPE polymer [polymer (P*)] having a viscosity higher than 2,000 mm²/s at 20° C., and/or
suitable further ingredients.

16. The damping fluid according to claim 13, wherein polymer (P) complies with structural formula (I):
T-O-[A-B]_{z}-[A-B′]_{z′}-A-T′ (I)
wherein:
A is —(X)ₐ—O—(R_{f})—(X)_{b}— in which
(R_{f}) is a fully or partially fluorinated polyoxyalkylene chain,
X and X′, equal to or different from each other, are selected from —CF₂—, —CF₂CF₂— and —CF(CF₃)—;
a and b, equal to or different from each other, are integers equal to 0 or 1 with the proviso that the block A linked to the end group T-O— has a=1 and the block A linked to the end group T′ has b=0;
B and B′, identical or different each other, are recurring units derived from at least one olefin having 2 to 10 carbon atoms, optionally comprising at least one halogen atom and optionally comprising at least one heteroatom;
z is an integer higher than or equal to 2;
z′ is 0 or an integer higher than or equal to 1; with the proviso that z and z′ are such that the number average molecular weight of formula (I) is in the range 500-500,000;
T and T′, equal to or different from each other, are hydrogen atom or a group selected from —CF₂H, —CF₂CF₂H, —CF₃, —CF₂CF₃, —CF₂CF₂CF₃, —CF₂Cl, —CF₂CF₂Cl, —C₃F₆Cl, —CF₂Br.

17. The damping fluid according to claim 16, wherein chain (R_{f}) comprises repeating units R°, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, or H;
(iv) —CF₂CF₂CF₂CF₂O—;
(v) —(CF₂)_{w}—CFZ—O— wherein w is an integer from 0 to 3 and Z is a group of general formula —O—R_{(f-a)}—Y, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of each of X being independently F or CF₃ and Y being a C₁-C₃ perfluoroalkyl group.

18. The damping fluid according to claim 17, wherein B complies with formula (B-1)
—[(CR₁R₂—CR₃R₄)ⱼ(CR₅R₆—CR₇R₈)_{j′}]— (B-1)
in which
j is from 1 to 50,
j′ is from 0 to 50,
R₁, R₂, R₃, R₄, R₅, R₆, R₇, R₈, equal to or different from each other, are selected from hydrogen, halogen; C₁-C₆ (per)haloalkyl, C₁-C₆ alkyl, optionally containing at least one heteroatom selected from O, N, S; and C₁-C₆ oxy(per)fluoroalkyl.

19. The damping fluid according to claim 13, wherein polymer (P) has a viscosity of from 5,000 to 1,500,000 mm²/s at 20° C.
